(19) United States
(12) Patent Application Publication
(10) Pub. No.: US 2002/0136496 A1
(43) Pub. Date: Sep. 26, 2002

(54) Optical switches and variable optical attenuators with known electrical-power-failure state

(76) Inventor: Louay Eldada, Lexington, MA (US)

Correspondence Address: Samuels, Gauthier & Stevens LLP, Suite 3300, 225 Franklin Street, Boston, MA, 02110, US

(21) Appl. No.: 10/094,694

(22) Filed: Mar. 11, 2002

Related U.S. Application Data
(60) Provisional application No. 60/294,941, filed on May 31, 2001.
(60) Provisional application No. 60/274,968, filed on Mar. 12, 2001.

(51) Int. Cl. G02B 6/26; G02B 6/35

(52) U.S. Cl. 385/39; 385/31; 385/140; 385/16

(57) ABSTRACT

The invention is generally directed to integrated optical devices, such as switches and variable optical attenuators. A solid-state actuation mechanism (e.g., heat) is used to switch, attenuate, and/or trim the devices. The devices have a known state in the case of electrical power failure. Some disclosed designs direct optical signals out an output port of the device in the absence of power, while the other designs direct optical signals out a separate exhaust port in the absence of power.

### PRIORITY INFORMATION

This application claims priority from provisional application Ser. No. 60/294,941 filed May 31, 2001.

### BACKGROUND OF THE INVENTION

The invention relates to the field of optical components.

One method of increasing the transportable bandwidth in optical communications networks is a technique known as wavelength division multiplexing (WDM). WDM is a technology that combines two or more wavelengths of light for transmission along a single optical waveguide. Each wavelength represents a channel that can carry a bit stream, i.e. content. Transporting two or more wavelengths on a waveguide effectively increases the aggregate bandwidth of the waveguide. For example, if 40 wavelengths, each capable of 10 Gb/s are used on a single fiber, the aggregate bandwidth of the fiber becomes 400 Gb/s.

A similar manner of increasing transportable bandwidth has been termed dense wavelength division multiplexing (DWDM). DWDM generally involves combining a denser number of wavelengths onto a fiber than WDM. While DWDM deals with more difficult issues associated with multiplexing a larger number of wavelengths on a fiber, such as cross-talk and non-linear effects, WDM and DWDM are typically used interchangeably.

Optical space switches and variable optical attenuators (VOA) based on planar lightwave circuit (PLC) technology are becoming important optical components in optical networks such as WDM networks. Optical switches switch optical signals from one optical waveguide to another, while VOAs attenuate the intensity of the optical signal in an optical waveguide.

Optical switches and VOAs typically require power in order to be in a specific state. Mechanically actuated switches and attenuators, e.g. based on moving fibers or MicroElectroMechanical Systems (MEMS), can maintain their state upon loss of power because they can be latching.

In contrast to mechanically actuated switches and attenuators, latching is not practical in solid-state optical switches or VOA components. Solid-state switches or VOA components are made as planar layers of a material, e.g. silica glass or polymer-based, on a silicon wafer or similar substrate. Thermo-optic, electro-optic, magneto-optic, or stress-optic effects, or any combination thereof, are typically used to actuate the device. Electrical power is typically used to operate the components implementing these effects for actuation. Latching is not practical in typical solid-state switches or VOAs because no mechanical motion occurs during actuation. Some possibilities do exist to introduce latching in solid state switches or VOAs, such as poling of polymer molecules, which is a process that consists of changing the molecule orientation by applying a large voltage (e.g., 1000 Volts). The change in orientation remains in effect after the voltage is turned off. Yet, such approaches are not practical and are not used in optical communication components. There is a need, therefore, for solid-state switches and VOAs in which the state is known upon power failure (i.e., where an optical signal is directed), even if the state is independent of the pre-failure state.

### SUMMARY OF THE INVENTION

In one aspect, the present invention provides an optical device comprising an optical component and at least a first bypass path. The optical component has at least a first input port to receive at least a first optical signal. A portion of the first bypass path is formed near the first input port to create a first coupler. The first coupler is designed and fabricated to provide essentially 100% coupling of the first optical signal to the first bypass path in the absence of power such that the first bypass path routes the optical signal around the optical component to a known location.

Another aspect of the present invention provides an optical device comprising an interferometric switching component having at least a first input port to receive at least a first optical signal and first and second output ports. The first optical signal is output to either the first output port or the second output port depending on the state of an actuation mechanism coupled to the switching component. The switching component is designed and fabricated so that essentially 100% of the first optical signal is output the first output port in the absence of power to the actuation mechanism.

### BRIEF DESCRIPTION OF THE DRAWINGS

FIGS. 1a-b and 2a-c illustrate embodiments, according to the present invention, of optical space switches and VOAs, respectively, in which a bypass path is used to route an input optical signal to a specified output port in the absence of any actuation;

FIGS. 3a-6b illustrate specific embodiments of the switching or attenuating components to achieve the functions as described with respect to FIGS. 1a-b and 2a-c;

FIGS. 7a-b generally illustrate embodiments of optical space switches, according to the present invention, that use interferometric switching components in which the interferometric switching components are designed and fabricated to route an input optical signal to a specified output port in the absence of any actuation;

FIGS. 8-11 illustrate specific embodiments of the switching or attenuating components to achieve the functions as described with respect to FIGS. 7a and 7b;

FIGS. 12a-b and 13a-c illustrate embodiments, according to the present invention, of optical space switches and VOAs, respectively, in which a bypass path is used as an exhaust port to output an input optical signal in the absence of any actuation; and

FIGS. 14a-17b illustrate specific embodiments of the switching or attenuating components to achieve the functions as described with respect to FIGS. 12a-b and 13a-c.

### DETAILED DESCRIPTION OF THE INVENTION

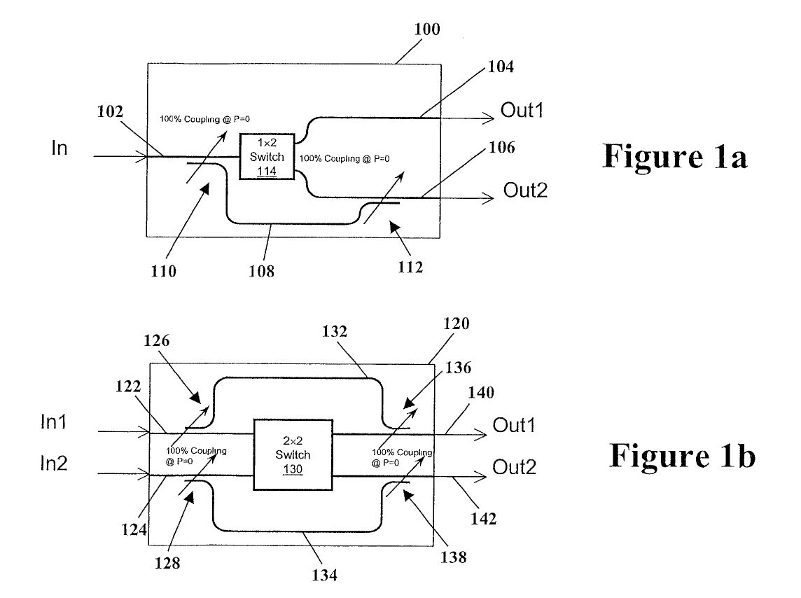

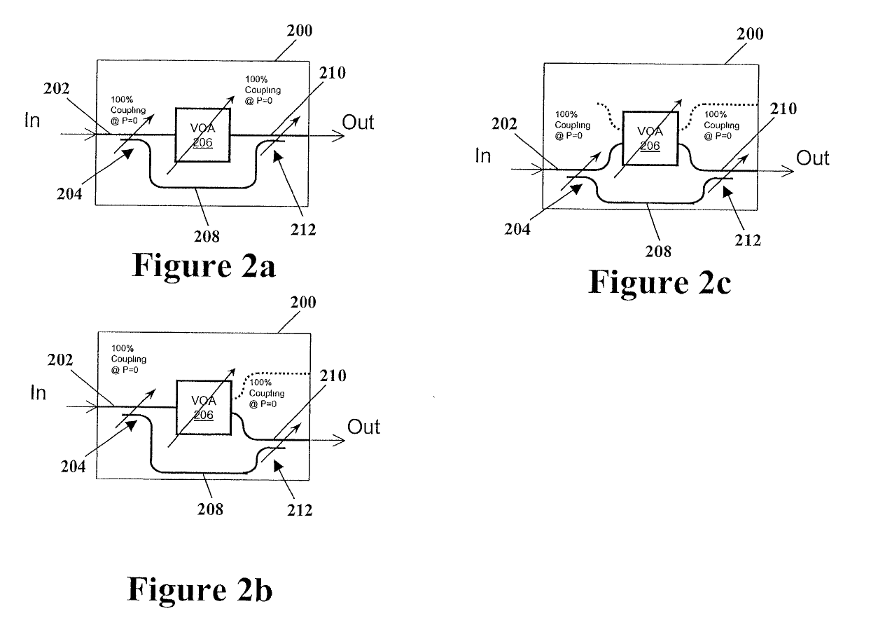

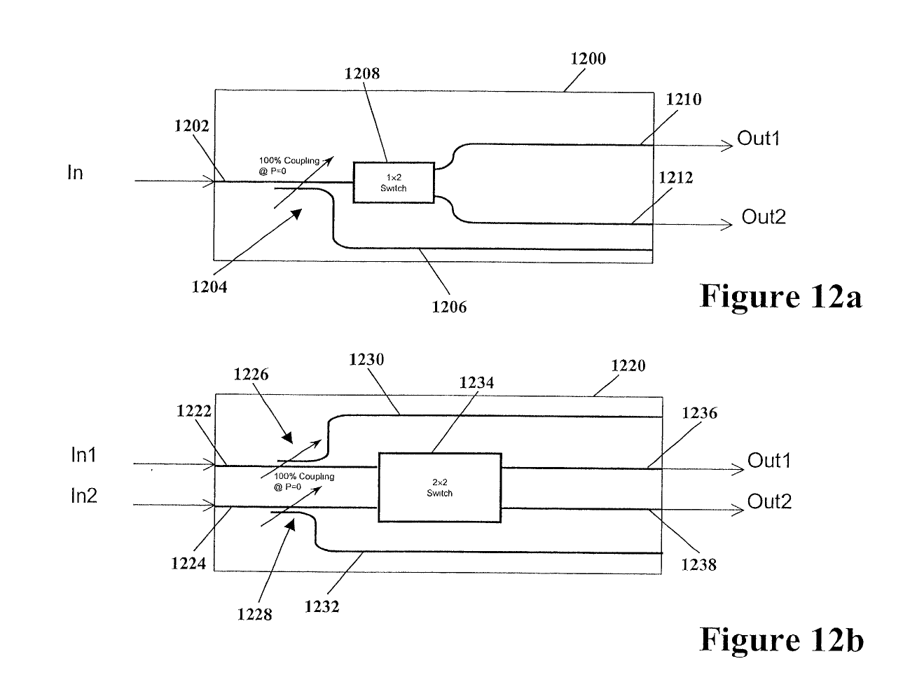

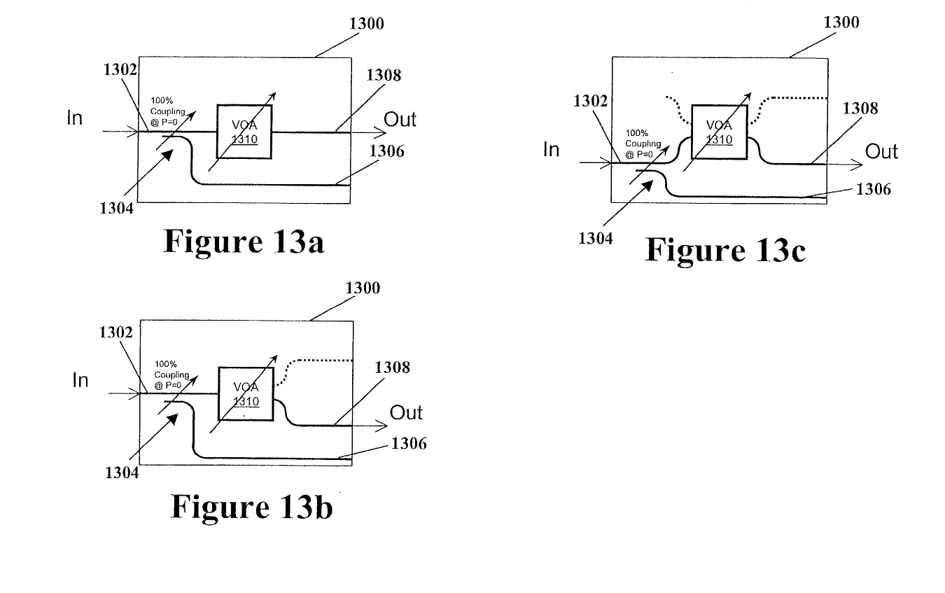

As described above, it is desirable to know the state of optical devices, such as optical space switches and VOAs, in the absence of actuation due to an electrical power failure. The present invention provides optical space switches and VOAs that are designed and fabricated to have a known state by directing optical signals to a known location in the absence of any actuation. That location can be an output port of the device, as illustrated in the embodiments of FIGS. 1-11, or a separate exhaust port, as illustrated in the embodiments of FIGS. 12-17.

FIGS. 1a-b and 2a-c illustrate embodiments of optical space switches and VOAs, respectively, in which a bypass path is used to route an input optical signal around the optical component to a specified output port in the absence of any actuation (i.e., when there is no electrical power).

FIG. 1a generally illustrates an embodiment of a 1×2 optical space switch in which an input optical signal bypasses the switching component of the device and goes straight to an output port in the absence of electrical power. As shown, a 1×2 switching component 114 is formed on a substrate 100, including an actuation mechanism. Switching component 114 has an input port 102 that receives an optical signal, a first output port 104 that outputs the received optical signal when the actuation mechanism is actuated to place switching component 114 in a first state, and a second output port 106 that outputs the received optical signal when the actuation mechanism is actuated to place switching component 114 in a second state. Each port is formed as an optical waveguide fabricated on substrate 100.

A bypass path 108 is also formed as an optical waveguide on substrate 100. A portion of bypass path 108 is formed close to input port 102 to create a first coupler 110. An actuation mechanism (illustrated by the arrow) is formed as part of coupler 110. When electrical power is applied, the actuation mechanism causes coupler 110 to couple essentially 0% of the optical power received at input port 102 to bypass path 108. In the absence of power for the actuation mechanism, however, coupler 110 couples essentially 100% of the optical power received at input port 102 to bypass path 108.

Similarly, a different portion of bypass path 108 is formed close to second output port 106 so as to create a second coupler 112. An actuation mechanism (illustrated by the arrow) is also formed as part of coupler 112. Coupler 112 is designed and fabricated such that, when electrical power is applied, the actuation mechanism causes coupler 112 to couple essentially 100% of the optical power on bypass path 108 to second output port 106. In the absence of power for the actuation mechanism, however, coupler 110 couples essentially 0% of the optical power output at output port 102 to bypass path 108.

Thus, when electrical power is applied and an optical signal is received at input port 102, the optical signal is not coupled to bypass path 108 and switching component 114 operates as normal, outputting the optical signal to first output port 104 or second output port 106 depending on the state of switching component 114. In the absence of electrical power, however, an optical signal received at input port 102 is coupled into bypass path 108 by coupler 110, bypasses switching component 114, and is coupled into second output port 106 by coupler 112.

To couple essentially 100% of the received optical signal into and out of bypass path 108 in the absence of electrical power, couplers 110 and 112 are fabricated with precise and predictable coupling without the need for active trimming (i.e., without need to adjust the coupling ratio by applying electrical power). In a preferred embodiment, couplers 110 and 112 are directional couplers. Prior art directional couplers are not fabricated with precise and predictable coupling absent electrical power because of the difficulty in precisely patterning the gap between the waveguides in the coupling region. Rather, the coupling ratio is adjusted by applying a small bias to the actuation mechanism to couple optical signals out one of the outputs, while a lager bias is used to actuate the coupler to couple optical signals out the other output. In accordance with the present invention, however, the gap between the waveguides in the coupling region is precisely patterned by applying one of the following design rules:

1) The gap has an aspect ratio of at least 1:1 (i.e., the width is at least as large as the height); or

2) No gap exists (i.e., the two waveguides merge as an essentially double-width waveguide in the coupling region).

Therefore, one of the above design rules is used to design couplers 110 and 112. Couplers 110 and 112 are then precisely fabricated on substrate 100 so that they do not require trimming to provide essentially 100% coupling in the absence of electrical power.

FIG. 1b generally illustrates an embodiment of a 2×2 optical space switch in which input optical signals bypass the switching component of the device and go straight to an output port in the absence of electrical power. As shown, a 2×2 switching component 130 is formed on a substrate 120, including an actuation mechanism. Switching component 130 has first and second input ports, 122 and 124 respectively, that receive optical signals. Switching component 130 also has first and second output ports 140 and 142 respectively, that output the received optical signals depending on the state of switching component 130. When switching component 130 is actuated to be in a first state, the optical signal received by first input port 122 is output to second output port 142, while the optical signal received on second input port 124 is output to first output port 140. Conversely, when switching component 130 is actuated to be in a second state, the optical signal received by first input port 122 is output to first output port 140, while the optical signal received on second input port 124 is output to second output port 142. Each port is formed as an optical waveguide fabricated on substrate 100.

A first bypass path 108 connecting first input 122 and first output 140 is also formed as an optical waveguide on substrate 100. A portion of first bypass path 132 is formed close to first input port 122 to create a first coupler 126, while a different portion of bypass path 132 is formed close to first output port 140 so as to create a second coupler 136. Actuation mechanisms (illustrated by the arrow) are formed as part of couplers 126 and 136.

Similarly, a second bypass path 134 connecting second input port 124 and second output port 142 is also formed as an optical waveguide on substrate 100. A portion of second bypass path 134 is formed close to second input port 124 to create a third coupler 128, while a different portion of bypass path 134 is formed close to second output port 142 so as to create a second coupler 138. Actuation mechanisms (illustrated by the arrow) are formed as part of couplers 128 and 138.

The couplers 126, 136, 128, and 138 are designed and fabricated in the same manner as described with respect to FIG. 1a such that, in the absence of electrical power, the bypass paths 132 and 134 route optical signals around switching component 130. Thus, when electrical power is applied and an optical signal is received at first input port 122, the optical signal is not coupled to first bypass path 132 and switching component 130 operates as normal, outputting the optical signal to first output port 140 or second output port 142 depending on the state of switching component 130. In the absence of electrical power, however, an optical signal received at first input port 122 is coupled into first bypass path 132 by coupler 126, bypasses switching component 130, and is coupled into first output port 140 by coupler 136. Likewise, when electrical power is applied and an optical signal is received at second input port 124, the optical signal is not coupled to second bypass path 134 and switching component 130 operates as normal, outputting the optical signal to first output port 140 or second output port 142 depending on the state of switching component 130. In the absence of electrical power, however, an optical signal received at second input port 124 is coupled into second bypass path 134 by coupler 128, bypasses switching component 130, and is coupled into second output port 142 by coupler 138.

FIG. 2a-c generally illustrate embodiments of a VOA in which an input optical signal bypasses the attenuating component of the device and goes straight to an output port in the absence of electrical power. FIG. 2a illustrates an embodiment in which the attenuating component is based on a 1×1 design. FIG. 2b illustrates an embodiment in which the attenuating component is based on a 1×2 design. FIG. 2c illustrates an embodiment in which the attenuating component is based on a 2×2 design.

In each embodiment, as shown, an attenuating component 206 is formed on a substrate 200. Attenuating component 206 has an input port 202 that receives an optical signal and an output port 210 that outputs the received optical signal after it is attenuated by attenuating component 206. Each port is formed as an optical waveguide fabricated on substrate 200.

Similar to the embodiment of FIG. 1a, a bypass path 208 connecting input port 202 and output port 210 is also formed as an optical waveguide on substrate 200. A portion of bypass path 208 is formed close to input port 202 to create a first coupler 204, while a different portion of bypass path 208 is formed close to output port 210 so as to create a second coupler 212. Actuation mechanisms (illustrated by the arrow) are formed as part of couplers 204 and 212.

The couplers 204 and 212 are designed and fabricated in the same manner as described with respect to FIG. 1a, such that, in the absence of electrical power, bypass path 208 routes optical signals around attenuating component 206. Thus, when electrical power is applied and an optical signal is received at input port 202, the optical signal is not coupled to bypass path 208 and attenuating component 206 operates as normal, attenuating the optical signal and outputting the attenuated signal to output port 210. In the absence of electrical power, however, an optical signal received at input port 202 is coupled into bypass path 208 by coupler 204, bypasses attenuating component 206, and is coupled into output port 210 by coupler 212.

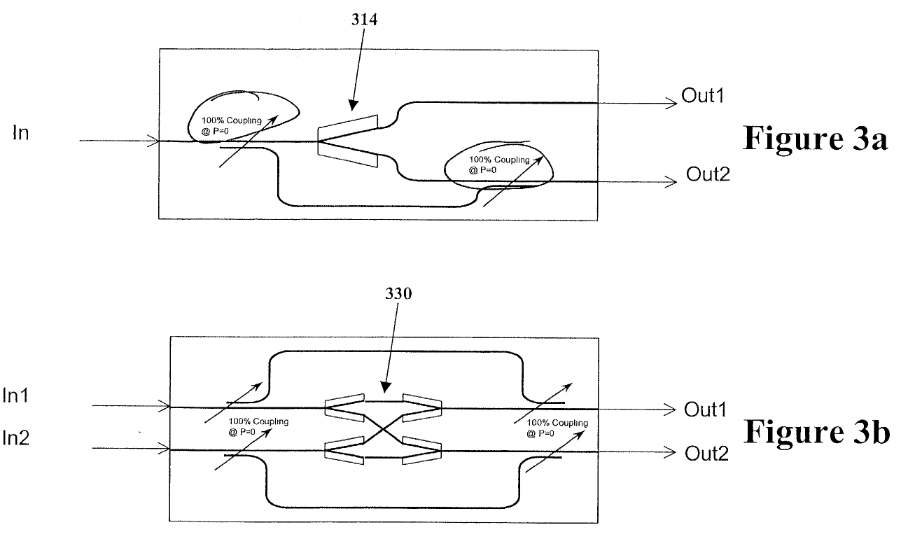

FIGS. 3a-6b illustrate specific embodiments of the switching or attenuating components to achieve the functions as described with respect to FIGS. 1a-b and 2a-c.

FIG. 3a illustrates an embodiment of the 1×2 designs of FIGS. 1a and 2b in which the switching or attenuating component is based on a Y-branch switch 314. When used as a VOA, only one input and one output is used. Similarly, FIG. 3b illustrates an embodiment of the 2×2 designs of FIGS. 1b and 2c in which the switching or attenuating component is based on a 2×2 DOS design 330. When used as a VOA, only one input and one output is used.

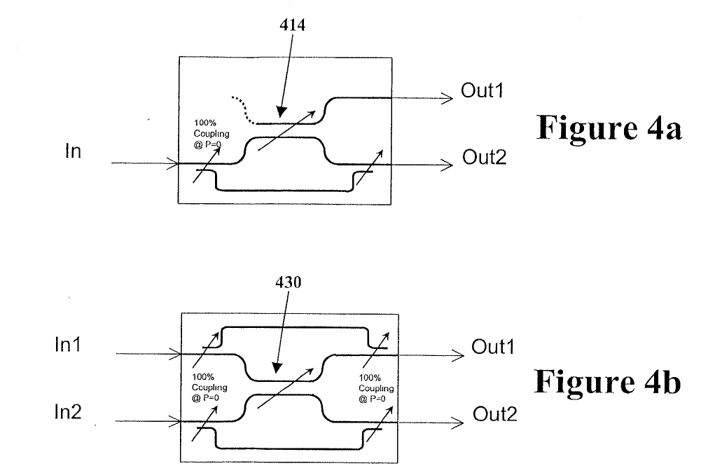

FIG. 4a illustrates an embodiment of the 1×2 designs of FIGS. 1a and 2b in which the switching or attenuating component is based on a 1×2 directional coupler 414. When used as a VOA, only one input and one output is used. Similarly, FIG. 4b illustrates an embodiment of the 2×2 designs of FIGS. 1b and 2c in which the switching or attenuating component is based on a 2×2 directional coupler 430. When used as a VOA, only one input and one output is used.

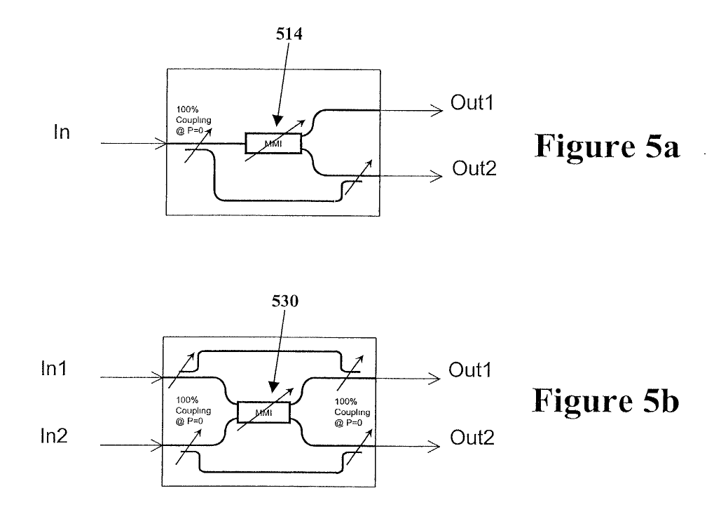

FIG. 5a illustrates an embodiment of the 1×2 designs of FIGS. 1a and 2b in which the switching or attenuating component is based on a 1×2 multi-mode interference (MMI) coupler 514. When used as a VOA, only one input and one output is used. Similarly, FIG. 5b illustrates an embodiment of the 2×2 designs of FIGS. 1b and 2c in which the switching or attenuating component is based on a 2×2 MMI coupler 530. When used as a VOA, only one input and one output is used.

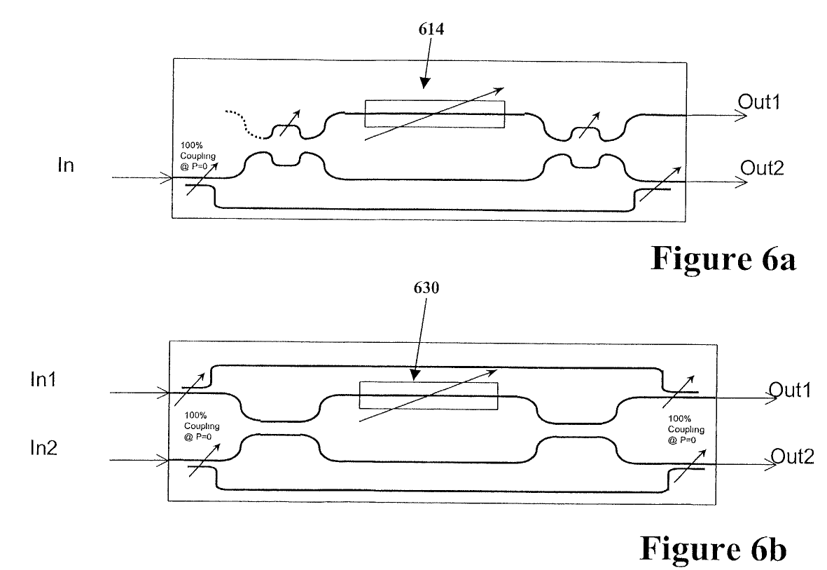

FIG. 6a illustrates an embodiment of the 1×2 designs of FIGS. 1a and 2b in which the switching or attenuating component is based on a 1×2 Mach-Zehnder Interferometer (MZI) 614. When used as a VOA, only one input and one output is used. Similarly, FIG. 6b illustrates an embodiment of the 2×2 designs of FIGS. 1b and 2c in which the switching or attenuating component is based on a 2×2 Mach-Zehnder Interferometer 630. When used as a VOA, only one input and one output is used.

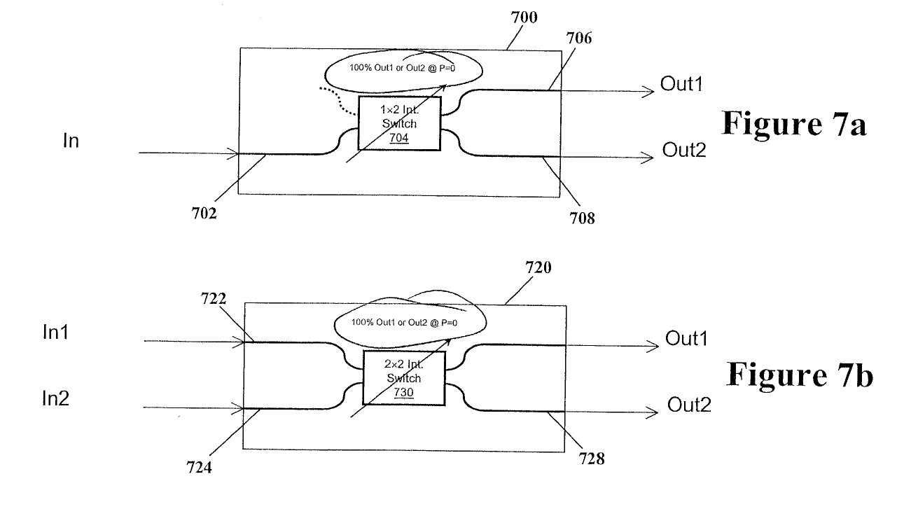

FIGS. 7a-b generally illustrate embodiments of optical space switches that use interferometric switching components in which the interferometric switching components are designed and fabricated to route an input optical signal to a specified output port in the absence of any actuation (i.e., when there is no electrical power).

FIG. 7a illustrates a switch in which a 1×2 interferometric switching component 704 is formed on substrate 700, including an actuation mechanism coupled to switching component 704. Switching component 704 has an input port 702 that receives an optical signal, a first output port 706 that outputs the received optical signal when the actuation mechanism is actuated to place switching component 704 in a first state, and a second output port 708 that outputs the received optical signal when the actuation mechanism is actuated to place switching component 704 in a second state. Each port is formed as an optical waveguide fabricated on substrate 700. Switching component 704 is designed and fabricated such that, in the absence of electrical power, an input optical signal traversing the device is routed interferometrically to one output of the device.

Thus, when electrical power is applied and an optical signal is received at input port 702, the optical signal is switched normally, i.e. to first output port 706 or second output port 708 depending on the actuation of switching component 704. In the absence of electrical power, however, an optical signal received at input port 702 is routed by switching component 704 to, for example, first output port 706.

FIG. 7b illustrates a switch in which a 2×2 interferometric switching component 730 is formed on substrate 720, including an actuation mechanism coupled to switching component 704. Switching component 730 has first and second input ports, 722 and 724 respectively, that receive optical signals. Switching component 730 also has first and second output ports, 726 and 728 respectively, that output the received optical signals depending on the state of switching component 730. When the actuation mechanism is actuated to place switching component 730 in a first state, the optical signal received by first input port 722 is output to second output port 728, while the optical signal received on second input port 724 is output to first output port 726. Conversely, when the actuation mechanism is actuated to place switching component 730 in a second state, the optical signal received by first input port 722 is output to first output port 726, while the optical signal received on second input port 724 is output to second output port 728. Each port is formed as an optical waveguide fabricated on substrate 700. Switching component 730 is designed and fabricated such that, in the absence of electrical power, an input optical signal received at first input port 722 and traversing the device is routed interferometrically to one output of the device, while an input optical signal received at second input port 724 and traversing the device is routed interferometrically to the other output of the device.

Thus, when electrical power is applied and an optical signal is received at first input port 722, the optical signal is switched normally, i.e. to first output port 726 or second output port 728 depending on the actuation of switching component 730. In the absence of electrical power, however, an optical signal received at first input port 722 is routed by switching component 730 to, for example, second output port 728. Likewise, when electrical power is applied and an optical signal is received at second input port 724, the optical signal is switched normally, i.e. to first output port 726 or second output port 728 depending on the actuation of switching component 730. In the absence of electrical power, however, an optical signal received at second input port 724 is routed by switching component 730 to the other output port, for example, first output port 726.

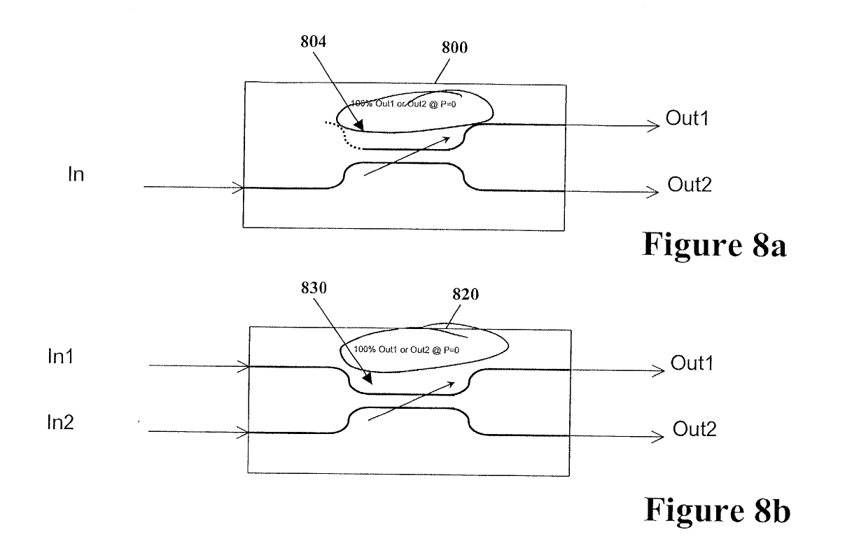

FIGS. 8-11 illustrate specific embodiments of the switching or attenuating components to achieve the functions as described with respect to FIGS. 7a and 7b.

FIG. 8a illustrates an embodiment of the 1×2 design of FIG. 7a in which the switching component is based on a 1×2 directional coupler 804 with an actuation mechanism formed therewith. To achieve the predictable routing of essentially 100% of a received optical signal to one of the output ports in the absence of electrical power, one of the design rules described above in relation to FIG. 1a is used to design coupler 804. Coupler 804 is then precisely fabricated on substrate 800 so that it does not require trimming to provide essentially 100% coupling in the absence of electrical power. Similarly, FIG. 8b illustrates an embodiment of the 2×2 design of FIG. 7b in which the switching component is based on a 2×2 directional coupler 830 with an actuation mechanism formed therewith. One of the design rules described above in relation to FIG. 1a is also used to design and fabricate coupler 830 so as to achieve the predictable routing of essentially 100% of a received optical signal to one of the output ports in the absence of electrical power.

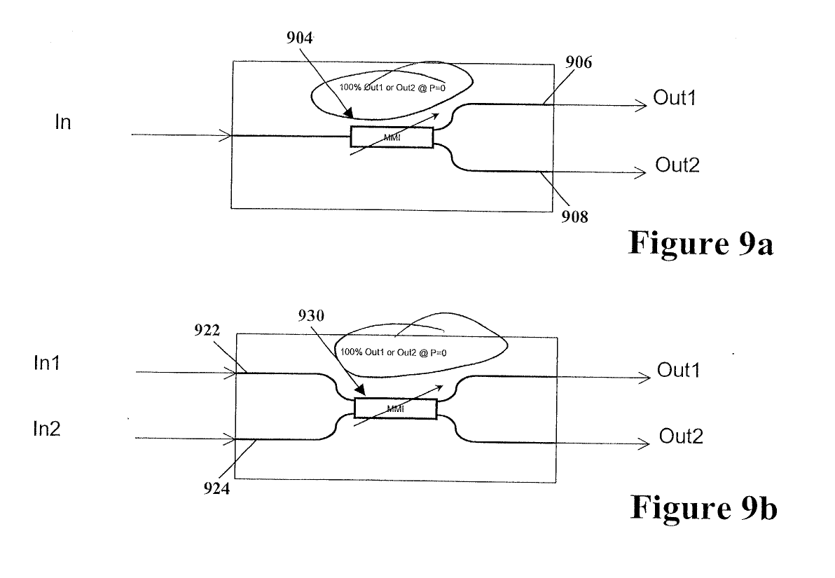

FIG. 9a illustrates an embodiment of the 1×2 design of FIG. 7a in which the switching component is based on a 1×2 MMI coupler 904 with an actuation mechanism formed therewith. MMI couplers of the prior art suffer from similar disadvantages as directional couplers. Therefore, in accordance with the present invention, a design rule is followed in order to produce MMI couplers with precise and predictable coupling without the need to adjust the coupling ratio by applying electrical power. To obtain the predictable routing of essentially 100% of a received optical signal to one of the output ports in the absence of electrical power, the output waveguides, 906 and 908, of MMI coupler 904 should have practically no evanescent coupling between them. This is achieved by designing the gap between them to have an aspect ratio of at least 2:1 (i.e., the gap width has to be at least twice as large as the height). When designed accordingly, the MMI can be fabricated to route essentially 100% of a received optical signal to one of the output ports in the absence of electrical power. Similarly, FIG. 9b illustrates an embodiment of the 2×2 design of FIG. 7b in which the switching component is based on a 2×2 MMI coupler 930 with an actuation mechanism formed therewith. The design rule described above in relation to FIG. 9a is also used to design and fabricate MMI coupler 930, however, the input waveguides, 922 and 924, should also have practically no evanescent coupling between them, which is achieved by designing the gap between them to have an aspect ratio of at least 2:1. By substantially eliminating the evanescent coupling, the predictable routing of essentially 100% of a received optical signal to one of the output ports in the absence of electrical power can be achieved.

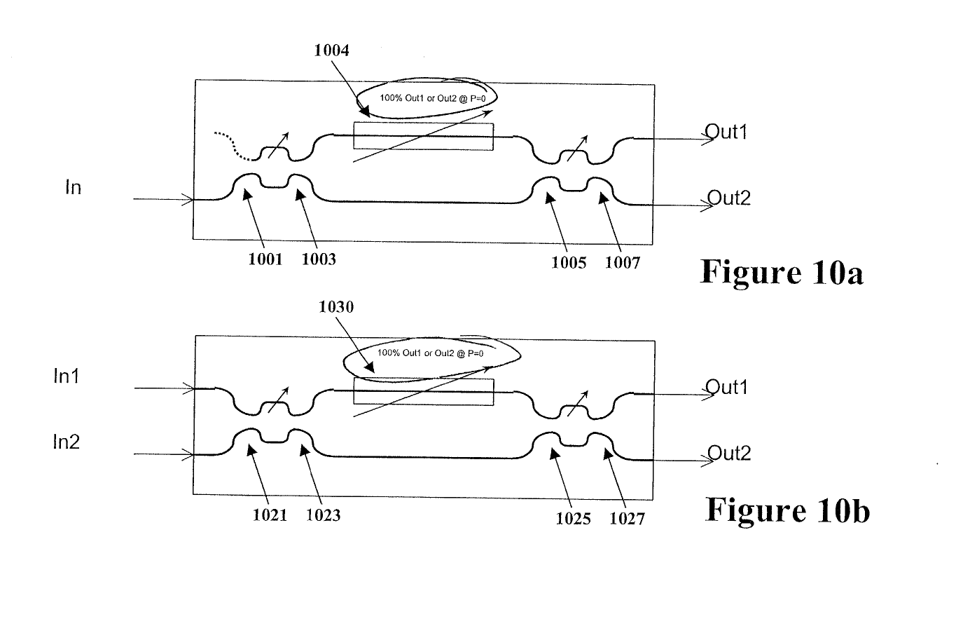

FIG. 10a illustrates an embodiment of the 1×2 design of FIG. 7a in which the switching component is based on a 1×2 MZI 1004 with an actuation mechanism formed in one arm thereof. In order to obtain the predictable routing of essentially 100% of a received optical signal to one of the output ports in the absence of electrical power, the coupling regions, 1001 and 1003, of the input 3 dB coupler and the coupling regions, 1005 and 1007, of the output 3 dB coupler are designed and fabricated in the same manner as the directional couplers described in the embodiment of FIG. 1a. Similarly, FIG. 10b illustrates an embodiment of the 2×2 design of FIG. 7b in which the switching component is based on a 2×2 MMI coupler 1030 with an actuation mechanism formed in one arm thereof. As with MZI 1004, the coupling regions, 1021 and 1023, of the input 3 dB coupler and the coupling regions, 1025 and 1027, of the output 3 dB coupler are also designed and fabricated in the same manner as the directional couplers described in the embodiment of FIG. 1a to obtain the predictable routing of essentially 100% of a received optical signal in the absence of electrical power.

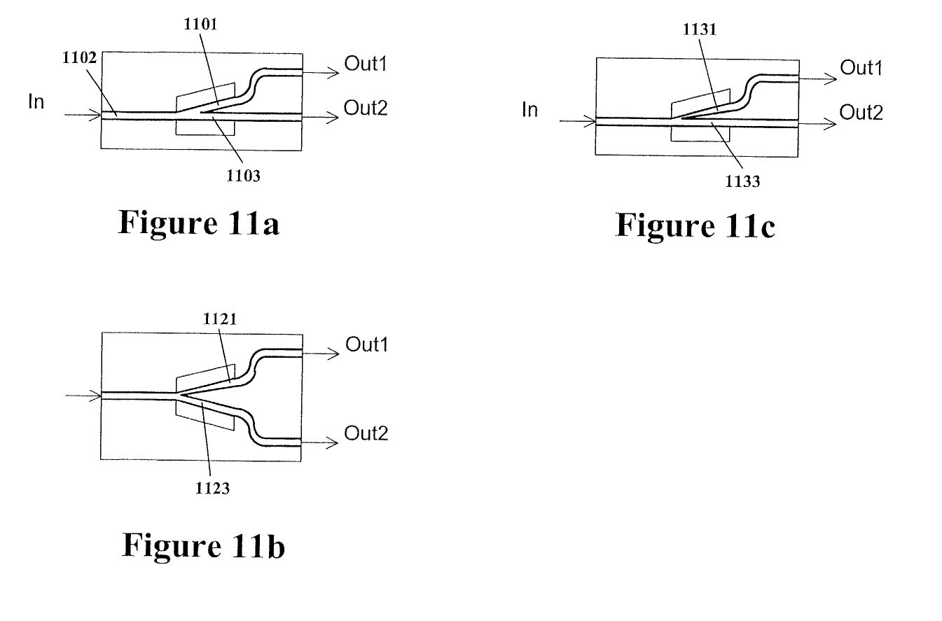

FIGS. 11a-c illustrate embodiments of the 1×2 design of FIG. 7a in which the switching component is a 1×2 DOS that is asymmetric by design such that, in the absence of electrical power, an input optical signal traversing the device is routed to one output of the device. One method of achieving such asymmetry is by having the angle of one arm of the Y-branch with respect to the input port be smaller than the angle of the other arm with respect to the input port. FIG. 11a shows a particular embodiment of achieving the asymmetry this way. As shown, arm 1101 has a non-zero angle with respect to input port 1102, while arm 1103 has a zero angle with respect to input port 1102. Another method of achieving such asymmetry is by having the width of one arm be smaller than the width of the other arm. In two specific cases of this embodiment, one arm has a uniform width similar to that of the input and output waveguides and the other arm (i) starts with a smaller width and tapers out to essentially the width of the first arm; or (ii) has a uniformly thin width for some length and then tapers out to essentially the width of the first arm. FIG. 11b illustrates the case in which first arm 1123 has a uniform width and second arm 1121 starts with a smaller width and tapers out to essentially the width of first arm 1123. A third method of achieving such asymmetry is by having both the angle asymmetry of FIG. 11a and the width asymmetry of FIG. 11b. This is illustrated in FIG. 11c, which shows arm 1131 with a non-zero angle and tapered width, while arm 1133 has a zero angle and uniform width.

FIGS. 12a-b and 13a-c illustrate embodiments of optical space switches and VOAs, respectively, in which a bypass path routes an input optical signal around the optical component and is used as an exhaust port to output the input optical signal in the absence of any actuation (i.e., when there is no electrical power).

FIG. 12a generally illustrates an embodiment of a 1×2 optical space switch in which, in the absence of electrical power, an input optical signal bypasses the switching component via a bypass path and is output by the bypass path. As shown, a 1×2 switching component 1208 is formed on a substrate 1200. Switching component 1208 has an input port 1202 that receives an optical signal, a first output port 1210 that outputs the received optical signal when switching component 1208 is actuated to be in a first state, and a second output port 1212 that outputs the received optical signal when switching component 1208 is actuated to be in a second state. Each port is formed as an optical waveguide fabricated on substrate 1200.

As with the embodiment of FIG. 1a, a bypass path 1206 is also formed as an optical waveguide on substrate 1200. A portion of bypass path 1206 is formed close to input port 1202 to create a first coupler 1204. An actuation mechanism (illustrated by the arrow) is formed as part of coupler 1204. Instead of being formed into a second coupler as with the embodiment of FIG. 1a, bypass path 1206 is routed to the edge of substrate 1200 and acts as an exhaust port to output the optical signal.

The coupler 1204 is designed and fabricated, however, in the same manner as described with respect to FIG. 1a such that, in the absence of electrical power, the bypass path 1206 routes optical signals around switching component 1208. Thus, when electrical power is applied and an optical signal is received at first input port 1202, the optical signal is not coupled to bypass path 1206 and switching component 1208 operates as normal, outputting the optical signal to first output port 1210 or second output port 1212 depending on the state of switching component 1208. In the absence of electrical power, however, an optical signal received at first input port 1202 is coupled into bypass path 1206, which acts as an exhaust port to output the optical signal.

FIG. 12b generally illustrates an embodiment of a 2×2 optical space switch in which, in the absence of electrical power, input optical signals bypass the switching component of the device via a respective bypass path and are output by the bypass path. As shown, a 2×2 switching component 1234 is formed on a substrate 1220. Switching component 1234 has first and second input ports, 1222 and 1224 respectively, that receive optical signals. Switching component 1234 also has first and second output ports, 1236 and 1238 respectively, that output the received optical signals depending on the state of switching component 1234. When switching component 1234 is actuated to be in a first state, the optical signal received by first input port 1222 is output to second output port 1238 while the optical signal received on second input port 1224 is output to first output port 1236. Conversely, when switching component 1234 is actuated to be in a second state, the optical signal received by first input port 1222 is output to first output port 1240, while the optical signal received on second input port 1224 is output to second output port 1236. Each port is formed as an optical waveguide fabricated on substrate 1220.

A first bypass path 1230 is also formed as an optical waveguide on substrate 1220. A portion of first bypass path 1230 is formed close to first input port 1222 to create a first coupler 1226. An actuation mechanism (illustrated by the arrow) is formed as part of coupler 1226. Instead of being formed into a second coupler as with the embodiment of FIG. 1b, bypass path 1230 is routed to the edge of substrate 1200 and acts as an exhaust port to output the optical signal.

Similarly, a second bypass path 1232 is formed as an optical waveguide on substrate 1220. A portion of second bypass path 1232 is formed close to second input port 1224 to create a second coupler 1228. An actuation mechanism (illustrated by the arrow) is formed as part of coupler 1228. Like bypass path 1230, bypass path 1232 is routed to the edge of substrate 1200 and acts as an exhaust port to output the optical signal.

The couplers 1226 and 1228 are designed and fabricated in the same manner as described with respect to FIG. 1a such that, in the absence of electrical power, the bypass paths 1230 and 1232 route optical signals around switching component 1234. Thus, when electrical power is applied and an optical signal is received at first input port 1222, the optical signal is not coupled to first bypass path 1230 and switching component 1234 operates as normal, outputting the optical signal to first output port 1236 or second output port 1238 depending on the state of switching component 1234. In the absence of electrical power, however, an optical signal received at first input port 1222 is coupled into first bypass path 1230 by coupler 1226, which acts as an exhaust port to output the optical signal. Likewise, when electrical power is applied and an optical signal is received at second input port 1224, the optical signal is not coupled to second bypass path 1232 and switching component 1234 operates as normal, outputting the optical signal to first output port 1236 or second output port 1238 depending on the state of switching component 1234. In the absence of electrical power, however, an optical signal received at second input port 1224 is coupled into second bypass path 1232 by coupler 1228, which acts as an exhaust port to output the optical signal.

FIG. 13a-c generally illustrate embodiments of a VOA in which, in the absence of electrical power, an input optical signal bypasses the attenuating component of the device via a bypass path, which acts as an exhaust port to output the optical signal. FIG. 13a illustrates an embodiment in which the attenuating component is based on a 1×1 design. FIG. 13b illustrates an embodiment in which the attenuating component is based on a 1×2 design. FIG. 13c illustrates an embodiment in which the attenuating component is based on a 2×2 design.

In each embodiment, as shown, an attenuating component 1310 is formed on a substrate 1300. Attenuating component 1310 has an input port 1302 that receives an optical signal and an output port 1308 that outputs the received optical signal after it is attenuated by attenuating component 1310. Each port is formed as an optical waveguide fabricated on substrate 1300.

Similar to the embodiment of FIG. 12a, a bypass path 1306 is also formed as an optical waveguide on substrate 1300. A portion of bypass path 1306 is formed close to input port 1302 to create a coupler 1304. An actuation mechanism (illustrated by the arrow) is formed as part of coupler 1304.

Coupler 1304 is designed and fabricated in the same manner as described with respect to FIG. 1a, such that, in the absence of electrical power, bypass path 1304 routes optical signals around attenuating component 1310. Thus, when electrical power is applied and an optical signal is received at input port 1302, the optical signal is not coupled to bypass path 1306 and attenuating component 1310 operates as normal, attenuating the optical signal and outputting the attenuated signal to output port 1308. In the absence of electrical power, however, an optical signal received at input port 1302 is coupled into bypass path 1306, which outputs the optical signal.

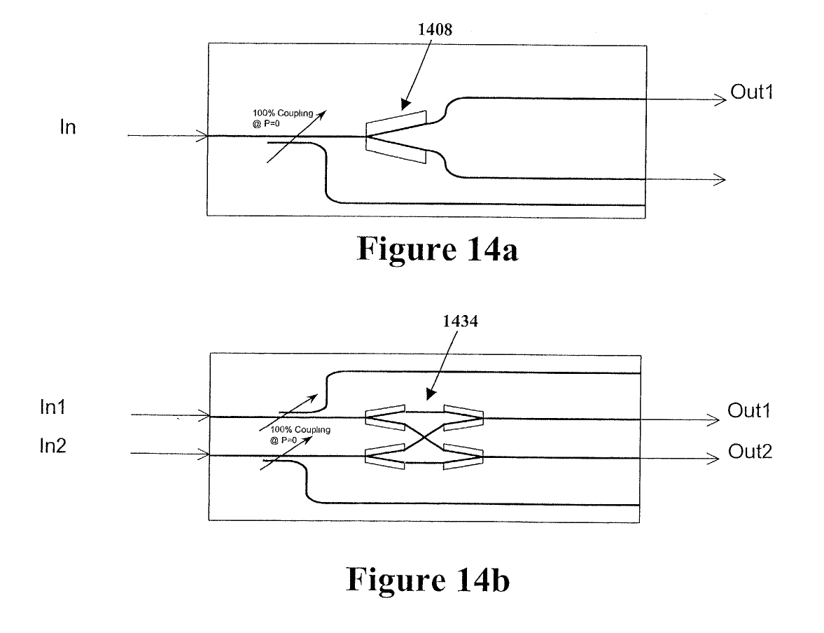

FIGS. 14a-17b illustrate specific embodiments of the switching or attenuating components to achieve the functions as described with respect to FIGS. 12a-b and 13a-c.

FIG. 14a illustrates an embodiment of the 1×2 designs of FIGS. 12a and 13b in which the switching or attenuating component is based on a Y-branch switch 1408. When used as a VOA, only one input and one output is used. Similarly, FIG. 14b illustrates an embodiment of the 2×2 designs of FIGS. 12b and 13c in which the switching or attenuating component is based on a 2×2 DOS design 1434. When used as a VOA, only one input and one output is used.

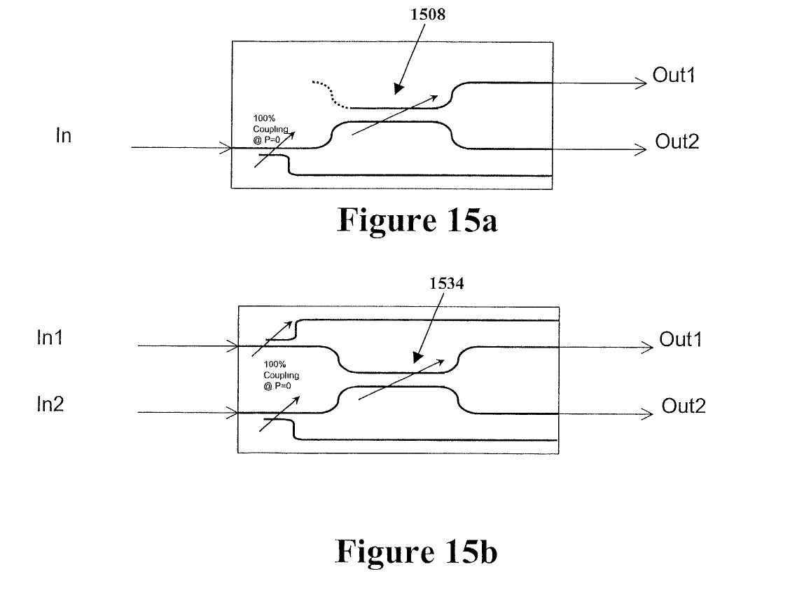

FIG. 15a illustrates an embodiment of the 1×2 designs of FIGS. 12a and 13b in which the switching or attenuating component is based on a 1×2 directional coupler 1508. When used as a VOA, only one input and one output is used. Similarly, FIG. 15b illustrates an embodiment of the 2×2 designs of FIGS. 12b and 13c in which the switching or attenuating component is based on a 2×2 directional coupler 1534. When used as a VOA, only one input and one output is used.

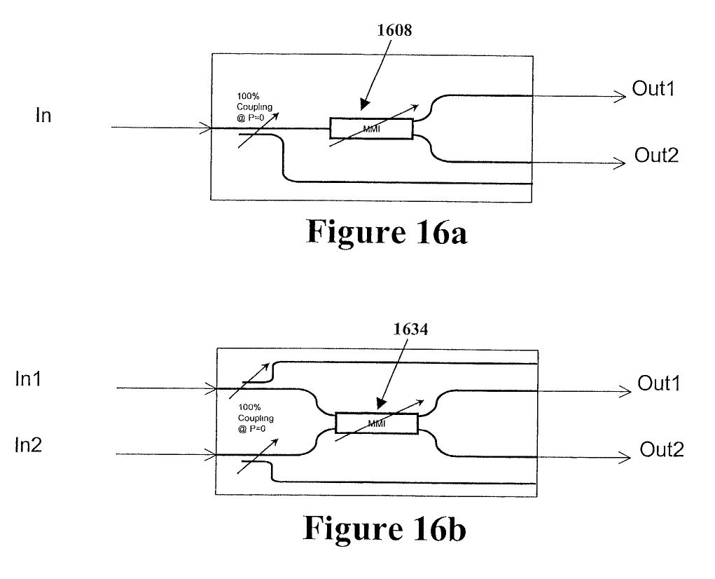

FIG. 16a illustrates an embodiment of the 1×2 designs of FIGS. 12a and 13b in which the switching or attenuating component is based on a 1×2 MMI coupler 1608. When used as a VOA, only one input and one output is used. Similarly, FIG. 16b illustrates an embodiment of the 2×2 designs of FIGS. 12b and 13c in which the switching or attenuating component is based on a 2×2 MMI coupler 1634. When used as a VOA, only one input and one output is used.

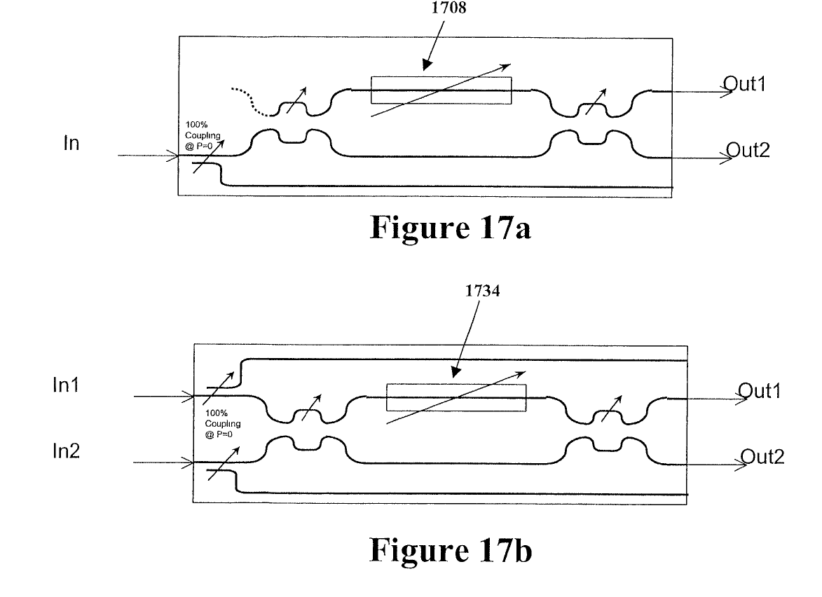

FIG. 17a illustrates an embodiment of the 1×2 designs of FIGS. 12a and 13b in which the switching or attenuating component is based on a 1×2 Mach-Zehnder Interferometer (MZI) 1708. When used as a VOA, only one input and one output is used. Similarly, FIG. 17b illustrates an embodiment of the 2×2 designs of FIGS. 12b and 13c in which the switching or attenuating component is based on a 2×2 Mach-Zehnder Interferometer 1734. When used as a VOA, only one input and one output is used.

Although the present invention has been shown and described with respect to several preferred embodiments thereof, various changes, omissions and additions to the form and detail thereof, may be made therein, without departing from the spirit and scope of the invention.

What is claimed is:

1. An optical device comprising:
an optical component having at least a first input port to receive at least a first optical signal;
at least a first bypass path, wherein a portion of the first bypass path is formed near the first input port to create a first coupler; and
wherein the first coupler is designed and fabricated to provide essentially 100% coupling of the first optical signal to the first bypass path in the absence of power such that the first bypass path routes the optical signal around the optical component to a known location.

2. The optical device according to claim 1, wherein:
a the optical component has at least a first output port; and
wherein the first bypass path has a portion formed near the first output port to create a second coupler; and
wherein the second coupler is designed and fabricated to provide essentially 100% coupling of the first optical signal to the first output port in the absence of power such that the output port is the known location.

3. The optical device according to claim 2, wherein the optical component has a second input port to receive a second optical signal and a second output port, the device further comprising:
a second bypass path, wherein a portion of the second bypass path is formed near the second input port to create a third coupler and a portion of the second bypass path is formed near the second output port to form a fourth coupler;
wherein the third coupler is designed and fabricated to provide essentially 100% coupling of the second optical signal to the second bypass path in the absence of power such that the second bypass path routes the optical signal around the optical component to the fourth coupler; and
wherein the fourth coupler is designed and fabricated to provide essentially 100% coupling of the input optical signal to the second output port in the absence of power to the optical device.

4. The optical device according to claim 3, wherein the optical component is a switching component.

5. The optical device according to claim 3, wherein the optical component is a variable attenuating component.

6. The optical device according to claim 2, wherein the optical component is a switching component.

7. The optical device according to claim 2, wherein the optical component is a variable attenuating component.

8. The optical device according to claim 1, wherein the first bypass path outputs the first optical signal such that an output of the first bypass path is the known location.

9. The optical device according to claim 8, wherein the optical component has a second input port to receive a second optical signal, the device further comprising:
a second bypass path, wherein a portion of the second bypass path is formed near the second input port to create a second coupler;
wherein the second coupler is designed and fabricated to provide essentially 100% coupling of the second optical signal to the second bypass path in the absence of power to the optical device such that the second bypass path routes the optical signal around the optical component and outputs the second optical signal.

10. The optical device according to claim 9, wherein the optical component is a switching component.

11. The optical device according to claim 9, wherein the optical component is a variable attenuating component.

12. The optical device according to claim 8, wherein the optical component is a switching component.

13. The optical device according to claim 8, wherein the optical component is a variable attenuating component.

14. The optical device according to claim 1, wherein the optical component is a switching component.

15. The optical device according to claim 1, wherein the optical component is a variable attenuating component.

16. An optical device according to claim 1, wherein the first coupler is a directional coupler.

17. An optical device according to claim 16, wherein the directional coupler is designed such that there is a gap between the bypass path and first input port that has a width to height ratio of at least one.

18. An optical device according to claim 16, wherein the directional coupler is designed such that the bypass path and first input port merge as an essentially double-width waveguide in a coupling region.

19. An optical device comprising:
an interferometric switching component having at least a first input port to receive at least a first optical signal and first and second output ports, wherein the first optical signal is output to either the first output port or the second output port depending on the state of an actuation mechanism coupled to the switching component; and
wherein the switching component is designed and fabricated so that essentially 100% of the first optical signal is output the first output port in the absence of power to the actuation mechanism.

20. An optical device according to claim 19, wherein the interferometric switch is based on a directional coupler designed to have two waveguides separated by a gap, wherein the gap has a width to height ratio of at least one.

21. An optical device according to claim 19, wherein the interferometric switch is based on a directional coupler designed to have two waveguides that merge as an essentially double-width waveguide in a coupling region.

22. An optical device according to claim 19, wherein the interferometric switch is based on a Mach-Zehnder Interferometer designed to have coupling regions in which two waveguides are separated by a gap, wherein the gap has a width to height ratio of at least one.

23. An optical device according to claim 19, wherein the interferometric switch is based on a Mach-Zehnder Interferometer designed with coupling regions in which two waveguides merge as a double-width waveguide.

24. An optical device according to claim 19, wherein the interferometric switch is based on a multi-mode interference coupler designed such that a gap between the first and second output ports has a width to height ratio of at least two.

25. An optical device according to claim 19, wherein the interferometric switch is based on a Y-branch switch having a first arm connected between the first input port and the first output port and a second arm connected between the first input port and the second output port, wherein the Y-branch switch is designed such that an angle of the first arm with respect to the first input port is smaller than an angle of the second arm with respect to the first input port.

26. An optical device according to claim 19, wherein the interferometric switch is based on a Y-branch switch having a first arm connected between the first input port and the first output port and a second arm connected between the first input port and the second output port, wherein the Y-branch switch is designed such that a width of the first arm is smaller than a width of the second arm.

27. An optical device according to claim 19, wherein:
the interferometric switching component has a second input port to receive a second optical signal, wherein the second optical signal is output to either the first output port or the second output port depending on the state of the actuation mechanism; and
wherein the switching component is designed and fabricated so that essentially 100% of the second optical signal is output the second output port in the absence of power to the actuation mechanism.
